(19) United States
(12) Patent Application Publication
(10) Pub. No.: US 2025/0242589 A1
(43) Pub. Date: Jul. 31, 2025

(54) LIQUID DISCHARGE HEAD, HEAD MODULE, LIQUID DISCHARGE APPARATUS, AND METHOD OF MANUFACTURING LIQUID DISCHARGE HEAD

(71) Applicant: Shigeru OBATA, Kanagawa (JP)

(72) Inventor: Shigeru OBATA, Kanagawa (JP)

(21) Appl. No.: 19/014,234

(22) Filed: Jan. 9, 2025

(30) Foreign Application Priority Data
Jan. 31, 2024 (JP) 2024-013096

(51) Int. Cl. B41J 2/14

(52) U.S. Cl. CPC B41J 2/14233; B41J 2202/20

(57) ABSTRACT

A liquid discharge head includes a head, a base, and a hydrophilic film. The head discharges a liquid. The base holds the head and has a blind screw hole having an inner circumferential face and a bottom face. The hydrophilic film covers the inner circumferential face and the bottom face of the blind screw hole.

### CROSS-REFERENCE TO RELATED APPLICATION

This patent application is based on and claims priority pursuant to 35 U.S.C. § 119 (a) to Japanese Patent Application No. 2024-013096, filed on Jan. 31, 2024, in the Japan Patent Office, the entire disclosure of which is hereby incorporated by reference herein.

### BACKGROUND

### Technical Field

The present disclosure relates to a liquid discharge head, a head module, a liquid discharge apparatus, and a method of manufacturing the liquid discharge head.

### Related Art

A liquid discharge head discharges a liquid such as ink from nozzles to print, for example, a desired image or characters on an object. Such a liquid discharge head is used in liquid discharge apparatuses in a wide range of fields. The liquid discharge head can discharge various types of liquids. Currently, the liquid discharge head is used in industrial applications, for example, to manufacture electrodes or electrochemical elements.

The liquid discharge head is fixed to a head mount (e.g., a carriage) of a liquid discharge apparatus via a base. An actuator die having a nozzle array is mounted on the base. The base has a screw hole to fix the liquid discharge head to the head mount by screw.

### SUMMARY

The present disclosure described herein provides an improved liquid discharge head including a head, a base, and a hydrophilic film. The head discharges a liquid. The base holds the head and has a blind screw hole having an inner circumferential face and a bottom face. The hydrophilic film covers the inner circumferential face and the bottom face of the blind screw hole.

Further, the present disclosure described herein provides an improved method of manufacturing a liquid discharge head. The method includes forming a blind screw hole having an inner circumferential face and a bottom face in a base of the liquid discharge head, forming a hydrophilic film on the inner circumferential face and the bottom face of the blind screw hole, and forming a plating film on the hydrophilic film.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is an external perspective view of a liquid discharge head;

FIG. 2 is a schematic view of a head module;

FIG. 3 is a schematic exploded perspective view of a liquid discharge head;

FIG. 4 is a schematic exploded perspective view of a liquid discharge head;

FIG. 5 is an external perspective view of a base;

FIG. 6 is a schematic perspective view of a base;

FIGS. 7A and 7B are a plan view and a cross-sectional view of a base, respectively;

FIGS. 8A and 8B are a plan view and a cross-sectional view of a base, respectively;

FIG. 9 is a schematic view of a printer as a liquid discharge apparatus;

FIG. 10 is a side view of a part of the liquid discharge apparatus of FIG. 9; and

FIG. 11 is a schematic view of an electrode manufacturing apparatus as a liquid discharge apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A liquid discharge head, a head module, a liquid discharge apparatus, and a method of manufacturing the liquid discharge head according to embodiments of the present disclosure will be described below with reference to the drawings. Embodiments of the present disclosure are not limited to the embodiments described below and may be other embodiments than the embodiments described below. The following embodiments may be modified by, for example, addition, modification, or omission within the scope that would be obvious to one skilled in the art. Any aspects having advantages as described for the following embodiments according to the present disclosure are included within the scope of the present disclosure.

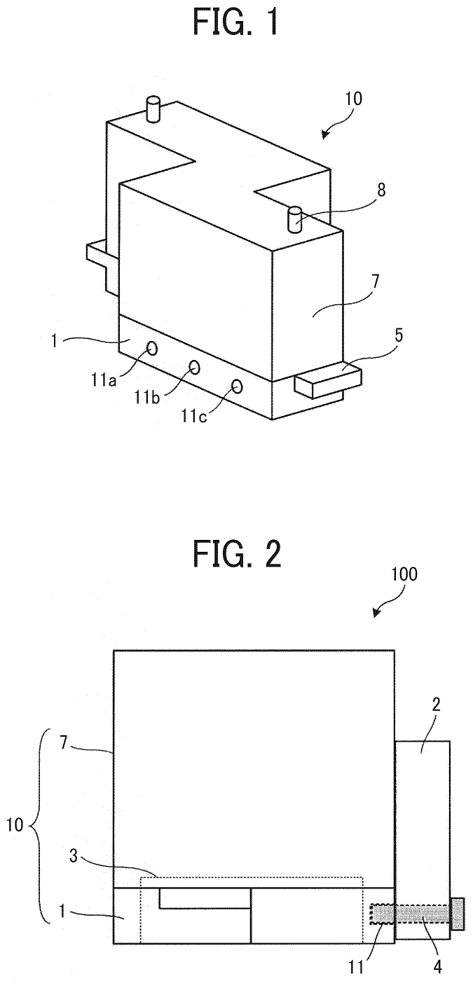

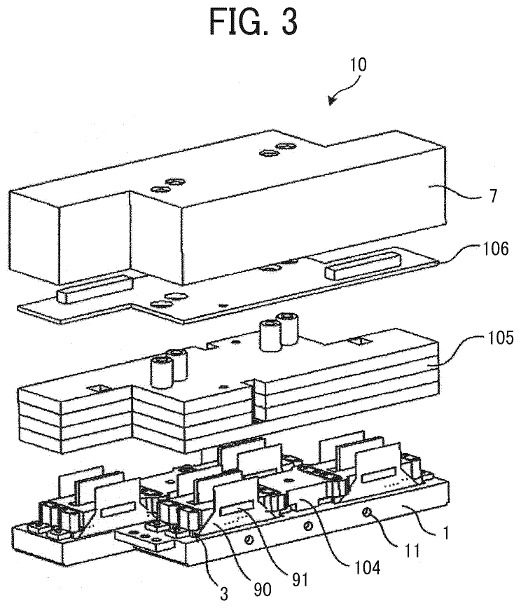

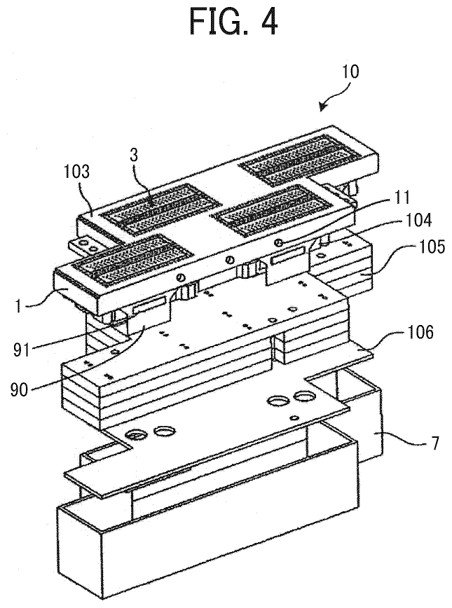

FIG. 1 is an external perspective view of a liquid discharge head. FIG. 2 is a schematic view of a head module. FIGS. 3 and 4 are schematic exploded perspective views of a liquid discharge head. The liquid discharge head is viewed from a nozzle face side of heads in FIG. 4. The number and arrangement of heads mounted on the liquid discharge head are not limited to the examples illustrated in FIGS. 1 to 4.

A liquid discharge head 10 includes heads 3 that discharge a liquid and a base 1 that holds the heads 3. The liquid discharge head 10 is fixed to a head mount 2 by a screw 4 inserted via the head mount 2. The base 1 has a blind (bottomed) screw hole 11 into which the screw 4 is inserted. The screw hole 11 has an inner circumferential face and a bottom face covered with a hydrophilic film.

A head module 100 includes the liquid discharge head 10, the head mount 2, and a screw 4 inserted into the screw hole 11, for example, via a through hole of the head mount 2 to fix the liquid discharge head 10 to the head mount 2. The head mount 2 is a functional component or mechanism of an apparatus to which the liquid discharge head 10 is attached, and examples of the head mount 2 include a moving mechanism such as a carriage and an attachment mechanism such as a plate.

The liquid discharge head 10 includes multiple heads 3 to discharge a liquid, the base 1, a nozzle cover 103, a heat dissipator 104, a manifold 105, a printed circuit board (PCB) 106, a case 7, and a supply port 8. In the liquid discharge head 10, the manifold 105 defines channels to supply a liquid to the multiple heads 3, and the PCB 106 is coupled to a flexible wiring board 90. A driver integrated circuit (IC) 91 is mounted on the flexible wiring board 90. The driver IC 91 is thermally coupled to the heat dissipator 104.

The base 1 is provided with a flange 5. The flange 5 has a through hole through which, for example, a screw can be inserted to attach the liquid discharge head 10 to another component. In contrast, the screw hole 11 formed in the base 1 of the liquid discharge head 10 is not a through hole. The screw hole 11 is disposed on a face different from the face on which the flange 5 is disposed.

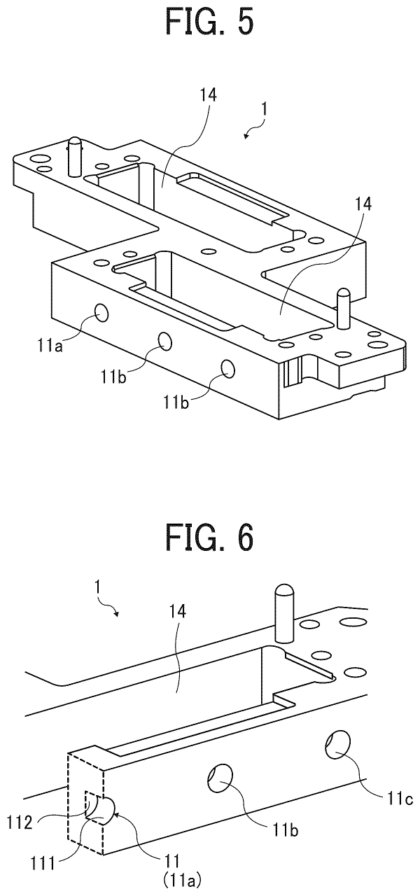

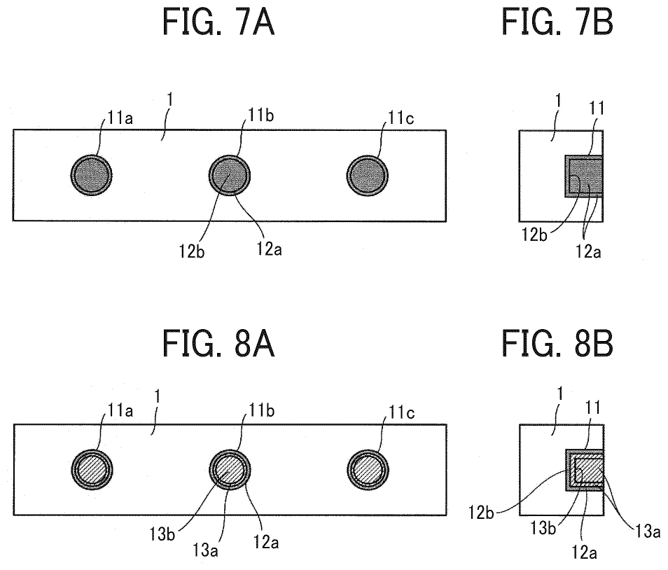

FIG. 5 is an external perspective view of the base 1 of the liquid discharge head 10. FIG. 6 is a schematic perspective view of a part of the base 1 of FIG. 5. FIGS. 7A and 8A are plan views of the base 1, and FIGS. 7B and 8B are cross-sectional views of the base 1.

The base 1 has an opening 14 for holding the head 3 on one face (i.e., a first face) of the base 1, and has a screw hole 11 on another face (i.e., a second face) of the base 1 different from the one face on which the opening 14 is disposed. The head 3 is fitted into the opening 14.

Although FIGS. 5, 6, 7A, and 8A illustrate three screw holes 11a, 11b, and 11c, the number of screw holes is not limited to three. In the following description, the screw holes 11a, 11b, and 11c may be collectively referred to as “screw holes 11,” each of which may be referred to as a “screw hole 11,” unless distinguished from each other. The screw hole 11 is formed on a side face of the base 1 and extends in a direction orthogonal to a liquid discharge direction of the head 3.

As illustrated in FIG. 2, the head mount 2 has a vertically long shape extending in the vertical direction (direction of gravity) in FIG. 2. The liquid discharge head 10 is supported by the side face of the head mount 2 to fix the liquid discharge head 10 to the head mount 2. Accordingly, even when the liquid discharge head 10 includes the multiple heads 3, the warping (bending) of the head mount 2 due to the weight of the liquid discharge head 10 can be prevented.

The screw hole 11 may be internally threaded so that the screw 4 can be fastened. In the liquid discharge head 10, the screw hole 11 is a non-through hole (blind hole) that does not penetrate the base 1 and has the bottom face so as to prevent liquid such as ink from entering the head 3 through the screw hole 11 of the base 1. Due to such a configuration, the liquid that has entered the screw hole 11 does not contact the head 3 during attachment and detachment of the liquid discharge head 10. As a result, the failure of the head 3 due to the liquid can be prevented.

On the other hand, in a plating process during manufacturing, bubbles are unlikely to escape from the non-through (blind) screw hole 11, and the screw hole 11 may not be filled with a plating solution. In addition, a cleaning liquid remaining in the screw hole 11 during manufacturing or a liquid that has entered the screw hole 11 during attachment and detachment of the liquid discharge head 10 may cause rust in the screw hole 11.

In the present embodiment, as illustrated in FIGS. 7A and 7B, the screw hole 11 of the base 1 of the liquid discharge head 10 is provided with a hydrophilic film 12 (12a and 12b) on an inner circumferential face 111 and a bottom face 112 (see FIG. 6). In other words, the hydrophilic film 12 covers the inner circumferential face 111 and the bottom face 112 of the screw hole 11.

FIGS. 7A and 7B illustrate the hydrophilic film 12a on the inner circumferential face 111 and the hydrophilic film 12b on the bottom face 112. In the following description, the hydrophilic films 12a and 12b may be collectively referred to as “hydrophilic films 12,” each of which may be referred to as a “hydrophilic film 12,” unless distinguished from each other.

Regarding the hydrophilic film 12, the term “hydrophilic” means a property having high affinity for water. The term “high affinity for water” means “likely to be solved in water” or “likely to be mixed with water,” and in particular, means that the surface of a substance is likely to be wetted with water. When water is attached to the surface of a substance having high hydrophilicity, the water does not form a droplet like a ball but spreads thinly to form a water film. In other words, water contacts the surface of a substance having high hydrophilicity with a contact angle close to 0 degrees.

The hydrophilic film 12 has a higher hydrophilicity than the base 1. The hydrophilic film 12 preferably includes particles of hydrophilic metal oxide, such as aluminum oxide or alumina (Al₂O₃) and silicon dioxide (SiO₂), as a main ingredient.

To form the hydrophilic film 12, for example, a coating agent including at least one of aluminum oxide or silicon dioxide is prepared, the screw hole 11 is coated with the coating agent to form a coating film, and the coating film may be heated if desired. The thickness of the hydrophilic film 12 is about 1 μm.

Since the hydrophilic film 12 is thin, if the hydrophilic film 12 peels off when the screw 4 is fastened, the effect of preventing rust may not be obtained. For this reason, a plating film 13 is preferably formed on the hydrophilic film 12 in the screw hole 11. The hydrophilic film 12 (hydrophilic treatment) helps bubbles escape from the screw hole 11 when the base 1 is immersed in a plating solution to form the plating film 13 (plating treatment). As a result, the plating film 13 can be easily formed.

FIGS. 8A and 8B illustrate the plating film 13 formed on the hydrophilic film 12. In the present embodiment, the screw hole 11 of the base 1 of the liquid discharge head 10 is provided with the hydrophilic film 12 (12a and 12b) and the plating film 13 (13a and 13b) on the inner circumferential face 111 and the bottom face 112 of the screw hole 11 (see FIG. 6).

FIGS. 8A and 8B illustrate the hydrophilic film 12a and the plating film 13a on the inner circumferential face 111 and the hydrophilic film 12b and the plating film 13b on the bottom face 112. In the following description, similarly to the hydrophilic film 12, the plating films 13a and 13b may be collectively referred to as “plating films 13,” each of which may be referred to as a “plating film 13,” unless distinguished from each other. As illustrated in FIGS. 8A and 8B, the plating film 13 is formed on the hydrophilic film 12.

The plating film 13 may be formed by, for example, electroless nickel plating. When the plating film 13 is formed (plating process), the entire base 1 is immersed in the plating solution, and thus a plating film is also formed on a portion other than the screw hole 11. The plating film 13 can reliably prevent rust caused by the attachment and detachment of the liquid discharge head 10 to and from the head mount 2.

A method of manufacturing the liquid discharge head 10 includes forming the bottomed (blind) screw hole 11, into which the screw 4 is inserted, in the base 1, forming the hydrophilic film 12 on the inner circumferential face 111 and the bottom face 112 of the screw hole 11, and forming the plating film 13 on the hydrophilic film 12.

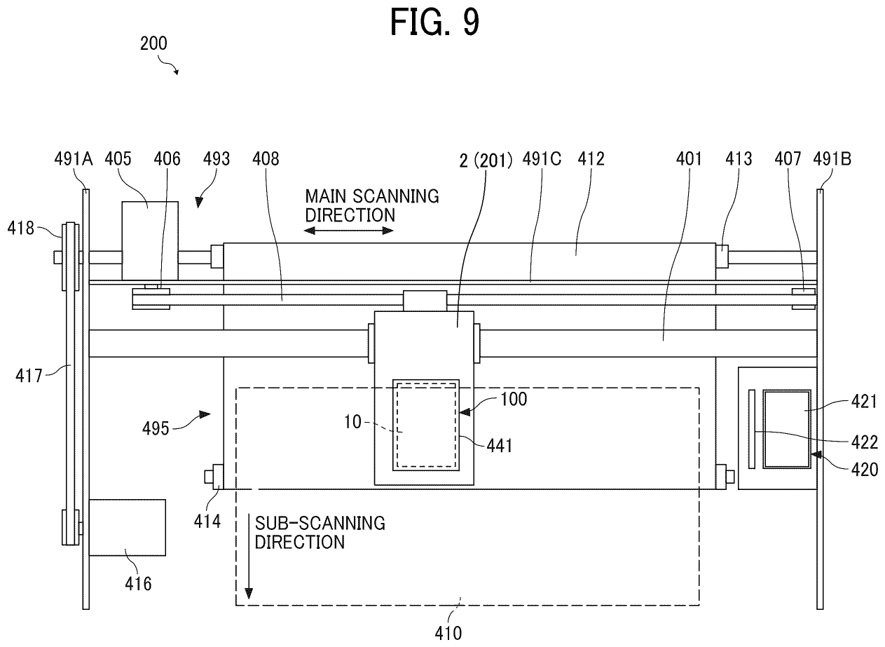

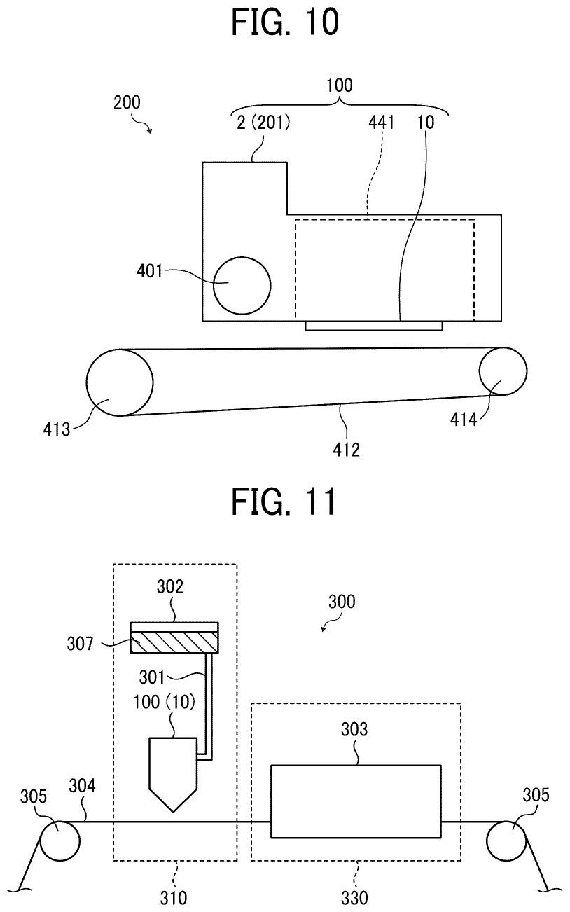

Liquid discharge apparatuses are described below with reference to FIGS. 9 to 11. FIG. 9 is a schematic view of a printer as a liquid discharge apparatus. FIG. 10 is a side view of a part of the printer of FIG. 9. FIG. 11 is a schematic view of an electrode manufacturing apparatus as a liquid discharge apparatus.

A liquid discharge apparatus according to an embodiment of the present disclosure includes a head module 100 including the head mount 2 to which the liquid discharge head 10 is fixed by the screw 4.

A printer 200 as the liquid discharge apparatus illustrated in FIG. 9 is a serial type apparatus. The printer 200 includes the head module 100 including a carriage 201 as an example of the head mount 2. In the head module 100, the liquid discharge head 10 is fixed to the carriage 201 by the screw 4.

A main-scanning moving mechanism 493 reciprocates the carriage 201 in a main scanning direction. The main-scanning moving mechanism 493 includes a guide 401, a main scanning motor 405, and a timing belt 408. The guide 401 is bridged between left and right side plates 491A and 491B to movably hold the carriage 201. The main scanning motor 405 reciprocates the carriage 201 in the main scanning direction via the timing belt 408 looped around a drive pulley 406 and a driven pulley 407.

The liquid discharge head 10 and a head tank 441 are mounted on the carriage 201 to form a single unit. This single unit may be referred to as a liquid discharge unit.

The liquid discharge head 10 discharges color liquids of, for example, yellow (Y), cyan (C), magenta (M), and black (K). The liquid discharge head 10 is mounted on the carriage 201 such that the nozzle array including multiple nozzles is arranged in the sub-scanning direction orthogonal to the main scanning direction. The liquid discharge head 10 discharges the color liquids downward (i.e., in the liquid discharge direction) from the multiple nozzles.

The printer 200 includes a conveyance mechanism 495 (i.e., a conveyor) to convey a sheet 410 (i.e., a medium) to the head module 100. The conveyance mechanism 495 includes a conveyance belt 412 and a sub-scanning motor 416 to drive the conveyance belt 412.

The conveyance belt 412 attracts the sheet 410 and conveys the sheet 410 at a position facing the liquid discharge head 10. The conveyance belt 412 is an endless belt looped around a conveyance roller 413 and a tension roller 414. The sheet 410 can be attracted to the conveyance belt 412 by, for example, electrostatic attraction or air suction.

The conveyance belt 412 circumferentially moves in the sub-scanning direction as the conveyance roller 413 is rotationally driven by the sub-scanning motor 416 via a timing belt 417 and a timing pulley 418.

On one end of the range of movement of the carriage 201 in the main scanning direction, a maintenance mechanism 420 that maintains and recovers the liquid discharge head 10 is disposed lateral to the conveyance belt 412. The maintenance mechanism 420 includes, for example, a cap 421 to cap the nozzle face (i.e., a face on which the nozzles are formed) of the liquid discharge head 10 and a wiper 422 to wipe the nozzle face.

The main-scanning moving mechanism 493, the maintenance mechanism 420, and the conveyance mechanism 495 are mounted onto a housing including the side plates 491A and 491B and a back plate 491C.

In the printer 200 having the above-described configuration, the sheet 410 is fed and attracted onto the conveyance belt 412 and conveyed in the sub-scanning direction by the circumferential movement of the conveyance belt 412. The liquid discharge head 10 is driven in response to an image signal while the carriage 201 is moved in the main scanning direction to discharge a liquid onto the sheet 410 not in motion to form an image.

The liquid discharge apparatus according to an embodiment of the present disclosure may also include an apparatus for manufacturing an electrode and an electrochemical element that is also referred to as an electrode manufacturing apparatus. The electrode manufacturing apparatus is an apparatus for manufacturing an electrode including a layer containing an electrode material by discharging a liquid composition using the head module 100 including the liquid discharge head 10.

An electrode manufacturing apparatus 300 as the liquid discharge apparatus illustrated in FIG. 11 is an apparatus for manufacturing an electrode by forming an electrode material layer on an object. A discharge device in the electrode manufacturing apparatus 300 illustrated in FIG. 11 is the head module 100 described above. The liquid discharge head 10 of the head module 100 discharges a liquid composition. By so doing, the liquid composition is applied onto an object, and a liquid composition layer is formed on the object.

### Device for Forming Layer Containing Electrode Material and Process of Forming Layer Containing Electrode Material

The object, which may also be referred to as a discharge target in the following description, is not limited to any particular object and may be appropriately selected depending on the intended purpose, as long as the object is an object on which a layer containing an electrode material is to be formed. Examples of the object include an electrode substrate, i.e., a current collector, an active material layer, and a layer containing a solid electrode material. The object may be an electrode composite layer containing an active material on an electrode substrate, i.e., a current collector. The discharge device and a discharge process may be a device and a process of forming a layer containing an electrode material by directly discharging a liquid composition as long as the layer containing an electrode material can be formed on a discharge target. The discharge device and the discharge process may be a device and a process of forming a layer containing an electrode material by indirectly discharging a liquid composition.

### Other Devices and Other Processes

Other configurations included in the electrode manufacturing apparatus for manufacturing an electrode composite layer are not limited to any particular configuration and may be appropriately selected depending on the intended purpose, as long as the effects of the present embodiment are not impaired. Other processes included in the method for manufacturing an electrode composite layer are not limited to any particular process and may be appropriately selected depending on the intended purpose, as long as the effects of the present embodiment are not impaired. For example, a heating device and a heating process are examples of the configuration and the process included in the electrode manufacturing apparatus and the manufacturing method of the electrode composite layer.

### Heating Device and Heating Process

The heating device included the electrode manufacturing apparatus for manufacturing an electrode composite layer is a device that heats the liquid composition discharged by the discharge device. The heating process included in the manufacturing method for manufacturing an electrode composite layer is a process of heating the liquid composition discharged in the discharge process. The liquid composition is heated to dry the liquid composition layer.

### Structure to Form Layer Containing Electrode Material by Direct Discharge of Liquid Composition

An electrode manufacturing apparatus according to an embodiment of the present disclosure, which forms an electrode composite layer containing an active material on an electrode substrate (current collector), is described below.

As illustrated in FIG. 11, the electrode manufacturing apparatus 300 includes a discharge process device 310 and a heating process device 330. The discharge process device 310 performs a discharge process of applying a liquid composition onto a print base material 304 having a discharge target to form a liquid composition layer. The heating process device 330 performs a heating process of heating the liquid composition layer to obtain an electrode composite layer.

The electrode manufacturing apparatus 300 includes a conveyor 305 that conveys the print base material 304. The conveyor 305 conveys the print base material 304 to the discharge process device 310 and the heating process device 330 in this order at a preset speed. A method of producing the print base material 304 having the discharge target such as an active material layer is not limited to any particular method, and a known method can be appropriately selected.

The discharge process device 310 includes the head module 100 including the liquid discharge head 10 that performs an application process of applying a liquid composition 307 onto the print base material 304, a storage container 302 that stores the liquid composition 307, and a supply tube 301 that supplies the liquid composition 307 stored in the storage container 302 to the liquid discharge head 10 of the head module 100.

The discharge process device 310 discharges the liquid composition 307 from the liquid discharge head 10 so that the liquid composition 307 is applied onto the print base material 304 to form a liquid composition layer in a thin film shape. The storage container 302 may be integrated with the electrode manufacturing apparatus that forms the electrode composite layer or may be detachable from the electrode manufacturing apparatus. The storage container 302 may be a container additionally attachable to a container integrated with the electrode manufacturing apparatus for manufacturing the electrode composite layer or to a container detachable from the electrode manufacturing apparatus for manufacturing the electrode composite layer. The storage container 302 that stably stores the liquid composition 307 and the supply tube 301 that stably supplies the liquid composition 307 can be used.

The heating process device 330 performs a solvent removing process of heating and removing the solvent remaining in the liquid composition layer. Specifically, the solvent that remains in the liquid composition layer is heated and dried by a heating device 303 of the heating process device 330. Accordingly, the solvent is removed from the liquid composition layer. Thus, the electrode composite layer is formed. The heating process device 330 may perform the solvent removing process under reduced pressure.

The heating device 303 is not limited to any particular heater and may be appropriately selected depending on the intended purpose. For example, the heating device 303 may be a substrate heater, an infrared (IR) heater, or a hot air heater. The heating device 303 may be a combination of at least two of the substrate heater, the IR heater, and the hot air heater. A heating temperature and heating time can be appropriately selected according to the boiling point of the solvent contained in the liquid composition 307 or the thickness of a formed film.

The electrode manufacturing apparatus 300 is used to discharge the liquid composition to a desired position on the discharge target. The electrode composite layer can be suitably used, for example, as a part of the configuration of an electrochemical element. The configuration of the electrochemical element other than the electrode composite layer is not limited to any particular configuration, and a known configuration can be appropriately selected. Examples of the configuration other than the electrode composite layer include a positive electrode, a negative electrode, and a separator.

The liquid discharge head 10 can prevent rust in the screw hole 11 into which the screw 4 is inserted to fix the liquid discharge head 10 to the head mount 2. The head module 100 in which the liquid discharge head 10 is fixed to the head mount 2 and the liquid discharge apparatus including the head module 100 can prevent the diffusion of rust and corrosion which are generated from the screw hole 11.

In the present disclosure, the liquid to be discharged is not limited to a particular liquid as long as the liquid has a viscosity or surface tension to be discharged from a head (liquid discharge head). However, preferably, the viscosity of the liquid is not greater than millipascal-second (mPa s) under ordinary temperature and ordinary pressure or by heating or cooling. Examples of the liquid to be discharged include a solution, a suspension, or an emulsion including, for example, a solvent, such as water or an organic solvent; a colorant, such as dye or pigment; a functional material, such as a polymerizable compound, a resin, or a surfactant; a biocompatible material, such as deoxyribonucleic acid (DNA), amino acid, protein, or calcium; and an edible material, such as a natural colorant. Such a solution, a suspension, or an emulsion can be used for, e.g., inkjet ink; surface treatment liquid; a liquid for forming an electronic element component, a light-emitting element component, or an electronic circuit resist pattern; or a material solution for three-dimensional fabrication.

Examples of an energy source for generating energy to discharge liquid include a piezoelectric actuator (a laminated piezoelectric element or a thin-film piezoelectric element), a thermal actuator that employs a thermoelectric transducer element, such as a thermal resistor, and an electrostatic actuator including a diaphragm and opposed electrodes.

The “liquid discharge unit” is an assembly of parts relating to liquid discharge. The term “liquid discharge unit” represents a structure including the liquid discharge head and a functional component(s) or mechanism(s) combined with the liquid discharge head as a single unit. For example, the “liquid discharge unit” includes a combination of the liquid discharge head with at least one of a head tank, a carriage, a supply mechanism, a maintenance mechanism, a main-scanning moving mechanism, or a liquid circulation device.

The term “liquid discharge apparatus” used herein also represents an apparatus including the liquid discharge head or the liquid discharge unit to drive the liquid discharge head to discharge liquid. The liquid discharge apparatus may be, for example, any apparatus that can discharge liquid to a medium onto which liquid can adhere or any apparatus to discharge liquid toward gas or into a different liquid.

The “liquid discharge apparatus” may further include devices relating to feeding, conveying, and ejecting of the medium onto which liquid can adhere and also include a pretreatment device and an aftertreatment device.

The “liquid discharge apparatus” may be, for example, an image forming apparatus to form an image on a sheet by discharging ink, or a three-dimensional fabrication apparatus to discharge fabrication liquid to a powder layer in which powder material is formed in layers, so as to form a three-dimensional object.

The “liquid discharge apparatus” is not limited to an apparatus that discharges liquid to visualize meaningful images such as letters or figures. For example, the liquid discharge apparatus may be an apparatus that forms patterns having no meaning or an apparatus that fabricates three-dimensional images.

The above-described term “medium onto which liquid can adhere” represents a medium on which liquid is at least temporarily adhered, a medium on which liquid is adhered and fixed, or a medium into which liquid adheres and permeates. Specific examples of the “medium onto which liquid can adhere” include, but are not limited to, a recording medium such as a paper sheet, recording paper, a recording sheet of paper, a film, or cloth, an electronic component such as an electronic substrate or a piezoelectric element, and a medium such as layered powder, an organ model, or a testing cell. The “medium onto which liquid can adhere” includes any medium to which liquid adheres, unless otherwise specified.

Examples of materials for the “medium onto which liquid can adhere” include any materials to which liquid can adhere even temporarily, such as paper, thread, fiber, fabric, leather, metal, plastic, glass, wood, and ceramic.

The liquid discharge apparatus may be an apparatus to move the liquid discharge head and the medium onto which liquid can adhere relative to each other. However, the liquid discharge apparatus is not limited to such an apparatus. For example, the liquid discharge apparatus may be a serial head apparatus that moves the liquid discharge head or a line head apparatus that does not move the liquid discharge head.

Examples of the liquid discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particle of the raw material.

The terms “image formation,” “recording,” “printing,” “image printing,” and “fabricating” used herein may be used synonymously with each other.

Aspects of the present disclosure are, for example, as follows.

### Aspect 1

A liquid discharge head includes a head and a base. The head discharges a liquid, and the base holds the head. The liquid discharge head is fixed to a head mount by a screw inserted from a side of the head mount. The base has a bottomed (blind) screw hole into which the screw is inserted. The screw hole has a hydrophilic film on an inner circumferential face and a bottom face.

In other words, a liquid discharge head includes a head, a base, and a hydrophilic film. The head discharges a liquid. The base holds the head and has a blind screw hole having an inner circumferential face and a bottom face. The hydrophilic film covers the inner circumferential face and the bottom face of the blind screw hole.

### Aspect 2

In the liquid discharge head according to Aspect 1, the hydrophilic film includes aluminum oxide and/or silicon dioxide.

In other words, the hydrophilic film includes at least one of aluminum oxide or silicon dioxide.

### Aspect 3

In the liquid discharge head according to Aspect 1 or 2, the base has an opening for holding the head. The screw hole is disposed on a face different from the opening.

In other words, the base has an opening on a first face of the base. The head is fitted into the opening of the base. The blind screw hole is disposed on a second face of the base different from the first face.

### Aspect 4

In the liquid discharge head according to any one of Aspects 1 to 3, the screw hole has a plating film on the hydrophilic film.

In other words, the liquid discharge head according to any one of Aspects 1 to 3, further includes a plating film on the hydrophilic film in the blind screw hole.

### Aspect 5

In a head module, the liquid discharge head according to any one of Aspects 1 to 4 is fixed to the head mount by the screw.

In other words, a head module includes the liquid discharge head according to any one of Aspects 1 to 4, a head mount having a through hole, and a screw inserted into the blind screw hole via the through hole of the head mount to fix the liquid discharge head to the head mount.

### Aspect 6

A liquid discharge apparatus includes the head module according to Aspect 5.

In other words, a liquid discharge apparatus includes the head module according to Aspect 5, to discharge the liquid to a medium, and a conveyor to convey the medium.

### Aspect 7

A liquid discharge apparatus includes the head module according to Aspect 5, to manufacture an electrode by forming an electrode material layer on an object.

In other words, a liquid discharge apparatus includes the head module according to Aspect 5, to discharge a liquid composition as the liquid to an object to form an electrode material layer on the object, and a storage container to store the liquid composition to be supplied to the head module.

### Aspect 8

In a method of manufacturing a liquid discharge head including a head for discharging a liquid and a base for holding the head, the liquid discharge head is fixed to a head mount by a screw inserted from a side of the head mount. The method includes forming a bottomed screw hole, into which the screw is inserted, in the base, forming a hydrophilic film on an inner circumferential face and a bottom face of the screw hole, and forming a plating film on the hydrophilic film.

In other words, a method of manufacturing a liquid discharge head includes forming a blind screw hole having an inner circumferential face and a bottom face in a base of the liquid discharge head, forming a hydrophilic film on the inner circumferential face and the bottom face of the blind screw hole, and forming a plating film on the hydrophilic film.

As described above, according to one aspect of the present disclosure, a liquid discharge head can be provided that prevents rust in a screw hole. A screw is inserted into the screw hole to fix the liquid discharge head to a head mount.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

1. A liquid discharge head comprising:
a head to discharge a liquid;
a base holding the head, the base having a blind screw hole having:
an inner circumferential face; and
a bottom face; and
a hydrophilic film covering the inner circumferential face and the bottom face of the blind screw hole.

2. The liquid discharge head according to claim 1,
wherein the hydrophilic film includes at least one of aluminum oxide or silicon dioxide.

3. The liquid discharge head according to claim 1,
wherein the base has an opening on a first face of the base,
the head is fitted into the opening of the base, and
the blind screw hole is disposed on a second face of the base different from the first face.

4. The liquid discharge head according to claim 1, further comprising:
a plating film on the hydrophilic film in the blind screw hole.

5. A head module comprising:
the liquid discharge head according to claim 1;
a head mount having a through hole; and
a screw inserted into the blind screw hole via the through hole of the head mount to fix the liquid discharge head to the head mount.

6. A liquid discharge apparatus comprising:
the head module according to claim 5, to discharge the liquid to a medium; and
a conveyor to convey the medium to the head module.

7. A liquid discharge apparatus comprising:
the head module according to claim 5, to discharge a liquid composition as the liquid to an object to form an electrode material layer on the object; and
a storage container to store the liquid composition to be supplied to the head module.

8. A method of manufacturing a liquid discharge head comprising:
forming a blind screw hole having an inner circumferential face and a bottom face in a base of the liquid discharge head;
forming a hydrophilic film on the inner circumferential face and the bottom face of the blind screw hole; and
forming a plating film on the hydrophilic film.
